(19) United States
(12) Patent Application Publication
(10) Pub. No.: US 2026/0039239 A1
(43) Pub. Date: Feb. 5, 2026

(54) PHOTOVOLTAIC SYSTEM

(71) Applicants: CSI CELLS CO., LTD., Suzhou, Jiangsu (CN); CANADIAN SOLAR MANUFACTURING (CHANGSHU) INC., Suzhou, Jiangsu (CN); CSI SOLAR CO., LTD., Suzhou, Jiangsu (CN)

(72) Inventors: Lei ZHAO, Suzhou (CN); Gang SHI, Suzhou (CN); Chuanguo FU, Suzhou (CN); Zhi YANG, Suzhou (CN); Tao XU, Suzhou (CN)

(73) Assignees: CSI CELLS CO., LTD., Suzhou, Jiangsu (CN); CANADIAN SOLAR MANUFACTURING (CHANGSHU) INC., Suzhou, Jiangsu (CN); CSI SOLAR CO., LTD., Suzhou, Jiangsu (CN)

(21) Appl. No.: 18/996,265

(22) PCT Filed: Aug. 11, 2023
(86) PCT No.: PCT/CN2023/112574

§ 371 Date: Jan. 17, 2025

(30) Foreign Application Priority Data
Aug. 12, 2022 (CN) 202210966176.7
Aug. 12, 2022 (CN) 202222130083.9
Aug. 12, 2022 (CN) 202222130746.7
Aug. 12, 2022 (CN) 202222130789.5

(51) Int. Cl. H02S 20/23

(52) U.S. Cl. CPC H02S 20/23

(57) ABSTRACT

A photovoltaic system includes a supporting metal sheet, which comprises a support sheet and a ridge structure extending upward from the surface of the support sheet. The system also includes several photovoltaic modules, each having a frame, and a mounting mechanism fixed to the supporting metal sheet. The mounting mechanism presses the photovoltaic modules onto the ridge structure. The present application achieves a stable installation by clamping the photovoltaic modules between the ridge structure and the mounting mechanism, thereby supporting the photovoltaic modules on the ridge structure.

### TECHNICAL FIELD

The present application relates to the field of photovoltaic technology, particularly to a photovoltaic system.

### BACKGROUND

Conventional installation methods for integrating photovoltaic modules with supporting metal sheets or building roofs include rail-mounted and rail-free installations. The rail-mounted installation method has the following drawbacks: 1) it requires the installation of tracks, which increases the system's weight and demands higher roof load capacity: 2) it increases material, transportation, and installation costs for the tracks.

The rail-free installation method reduces the system's weight, saves track material, and lowers transportation and installation costs. However, in the rail-free installation method, there is a method of embedding photovoltaic modules along the water flow direction of the supporting metal sheets. In this process, the conventional installation of photovoltaic modules with supporting metal sheets often results in inadequate connections, leading to potential failure risks.

Therefore, it is necessary to design a new photovoltaic system to address these issues.

### SUMMARY

The present application provides a photovoltaic system to overcome the technical problems associated with the current installation of photovoltaic modules embedded in supporting metal sheets.

To achieve the above objective, the technical solution provided in the present application is as follows:

A photovoltaic system, comprising: a supporting metal sheet, the supporting metal sheet comprising a support sheet and a ridge structure extending upward from the surface of the support sheet: a plurality of photovoltaic modules, each photovoltaic module comprising a frame: a mounting mechanism fixed to the supporting metal sheet and configured to press the photovoltaic modules onto the ridge structure.

As a further improvement of the present invention, wherein the mounting mechanism comprising: a pressing block structure, the pressing block structure comprising a fixing plate, a pair of vertical plates extending downward from the fixing plate, and a pressing plate located at a side of the fixing plate in the width direction, the length of the vertical plates being no greater than the height of the frame, the frame being located between the pressing plate and the ridge structure; a clamping structure located below the pressing block structure, the clamping structure comprising a pair of clamping arms located below the fixing plate, the pair of clamping arms forming a clamping space for accommodating the ridge structure, the inner diameter of the clamping space in the horizontal direction varying with the force applied to the pair of clamping arms.

As a further improvement of the present invention, the pressing block structure comprise one pressing plate located at any side of the fixing plate in the width direction; or the pressing block structure comprise two pressing plates, each pressing plate being located at opposite sides of the fixing plate in the width direction.

As a further improvement of the present invention, wherein when the pressing block structure comprise one pressing plate, the vertical plates comprise an outer vertical plate away from the pressing plate and an inner vertical plate close to the pressing plate, the thickness of the outer vertical plate being greater than the thickness of the inner vertical plate.

As a further improvement of the present invention, the clamping arms are fixed to the underside of the fixing plate or detachably connected to the underside of the fixing plate; or one of the clamping arms comprise a connecting plate extending from its upper end, the other clamping arm being pivotally connected to the connecting plate, the connecting plate being located between the pair of vertical plates.

As a further improvement of the present invention, wherein the fixing plate and the pair of vertical plates form an mounting groove, the connecting plate being located within the mounting groove, and the longitudinal direction of the connecting plate being aligned with the longitudinal direction of the fixing plate.

As a further improvement of the present invention, wherein the mounting mechanism further comprises a connection component for connecting the pressing block structure and the clamping structure, the connection component comprising a fastener, a through hole in the fixing plate for the fastener to pass through, and a mounting hole in the connecting plate that cooperates with the fastener.

As a further improvement of the present invention, wherein the mounting mechanism further comprises a positioning structure located between the pressing block structure and the clamping structure, the positioning structure comprising a pair of positioning plates located below the fixing plate, the positioning plates extending in the vertical direction, and the ends of the positioning plates being configured to abut against the outer side of the clamping arms when the positioning plates move in the vertical direction.

As a further improvement of the present invention, the positioning structure further comprise a connecting plate located below the fixing plate, the pair of positioning plates being respectively fixed to the ends of the connecting plate in the longitudinal direction, and a through hole being provided in the connecting plate at a position corresponding to the mounting hole for the fastener to pass through; or the pair of positioning plates are respectively fixed to the ends of the fixing plate in the longitudinal direction, and the positioning plates extend downward from the ends of the fixing plate.

As a further improvement of the present invention, the ridge structure comprises a top plate for supporting the frame and a pair of side plates extending downward and away from each other from the ends of the top plate in the width direction, the side plates having a locking groove formed inwardly between the pair of side plates; the clamping structure further comprise a clamping plate located at the lower end of each clamping arm, the clamping plates extending toward each other from the ends of the clamping arms, and the angle between the clamping plate and the clamping arm being an acute angle.

As a further improvement of the present invention, the ridge structure comprises a top plate for supporting the frame, a pair of side plates extending downward and away from each other from the ends of the top plate, the side plates comprising a top wall extending inwardly between the pair of side plates, the angle between the top wall and the side plates being an acute angle; the photovoltaic system further comprises a central bracket, the central bracket comprising a support base, a pair of support plates extending upward from the support base, and a locking plate connected to the upper ends of the support plates and extending away from the other support plate, the support plates and the locking plate being configured to be inserted into the ridge structure, and the locking plate being located above the top wall.

As a further improvement of the present invention wherein the angle between the locking plate and the support plate is smaller than the angle between the top wall and the support plate.

As a further improvement of the present invention, wherein the central bracket further comprise a support plate connected to the pair of locking plates, the support plate comprising a pair of first support plates for supporting the side plates above the top wall and a second support plate for supporting the top plate.

As a further improvement of the present invention, wherein the width of the top of the support plate is greater than the width of the bottom, and/or at least one of the support plate and the support base is provided with a reinforcing rib.

15. The photovoltaic system according to claim 1, wherein the supporting metal sheet further comprises a first connecting structure and a second connecting structure respectively provided at the ends in the width direction, the first connecting structure being installed with the second connecting structure of an adjacent supporting metal sheet, and the height of the ridge structure being greater than the height of the first connecting structure and the second connecting structure.

Compared to the prior art, the advantageous effects of the photovoltaic system of the present application are as follows: in the photovoltaic system of the present invention, the photovoltaic module is pressed onto the ridge structure by the mounting mechanism, i.e., the photovoltaic modules are clamped between the ridge structure and the mounting mechanism, thereby supporting the photovoltaic modules on the ridge structure, resulting in a stable installation structure.

Beneficial effects of the present invention are as follows: Selectivity of forming processes is expanded by setting the microstructures as the hollow protrusions. For example, the microstructure sheets and the gaskets for microstructure sheets can be formed by a stamping process. Compared with a conventional etching process, the stamping process is simple, low in production cost, high in production efficiency, and low in environmental pollution.

### BRIEF DESCRIPTION OF THE DRAWINGS

FIG. 1 is a stereoscopic schematic structural diagram of a photovoltaic system according to one embodiment of the present application.

FIG. 2 is an enlarged view of section A in FIG. 1.

FIG. 3 is an enlarged view of section B in FIG. 1.

FIG. 4 is a front view of the photovoltaic system in FIG. 1.

FIG. 5 is an enlarged view of section C in FIG. 4.

FIG. 6 is an enlarged view of section D in FIG. 4.

FIG. 7 is a stereoscopic structural schematic diagram of a supporting metal sheet in the embodiment of FIG. 1.

FIG. 8 is a schematic structural diagram of two adjacent supporting metal sheets cooperating with each other in FIG. 1.

FIG. 9 is an enlarged view of section E in FIG. 8.

FIG. 10 is a stereoscopic schematic structural diagram of the central bracket in FIG. 1.

FIG. 11 is a stereoscopic schematic structural diagram of the edge bracket in FIG. 1.

FIG. 12 is a schematic structural diagram of the central bracket in another embodiment of the present application.

FIG. 13 is a schematic diagram of the central bracket in FIG. 12 in cooperation with the supporting metal sheet.

FIG. 14 is a stereoscopic schematic structural diagram of the mounting mechanism in one embodiment of the present application.

FIG. 15 is an exploded view of the mounting mechanism in FIG. 14.

FIG. 16 is a schematic structural diagram of the mounting process of the positioning structure and clamping structure in FIG. 14 at different stages.

FIG. 17 is a stereoscopic schematic structural diagram of the mounting mechanism in another embodiment of the present application.

FIG. 18 is an exploded view of the mounting mechanism in FIG. 17.

FIG. 19 is an exploded view of the mounting mechanism in FIG. 17 from another angle.

### DETAILED DESCRIPTION

To enable those skilled in the art to better understand the technical solutions of the present application, the technical solutions of the embodiments of the present application will be clearly and completely described below with reference to the drawings of the embodiments of the present application. It is evident that the described embodiments are merely a part of the embodiments of the present application, not all of them. All other embodiments obtained by a person of ordinary skill in the art based on the embodiments of the present application without creative efforts should fall within the protection scope of the present application.

It should be noted that the orientation or positional relationships indicated in the present application are based on the orientation or positional relationships shown in the drawings, which are merely for the convenience of simplifying the description of the present application and do not indicate or imply that the device or element being referred to must have a specific orientation or be constructed and operated in a specific orientation. Therefore, they should not be construed as limiting the protection scope of the present application. The term “downward” refers to the direction toward the ground, and “upward” refers to the direction away from the ground.

In the various drawings of the present application, for the convenience of illustration, the dimensions of certain structures or parts may be exaggerated relative to other structures or parts, and thus are only intended to illustrate the basic structure of the subject matter of the present application.

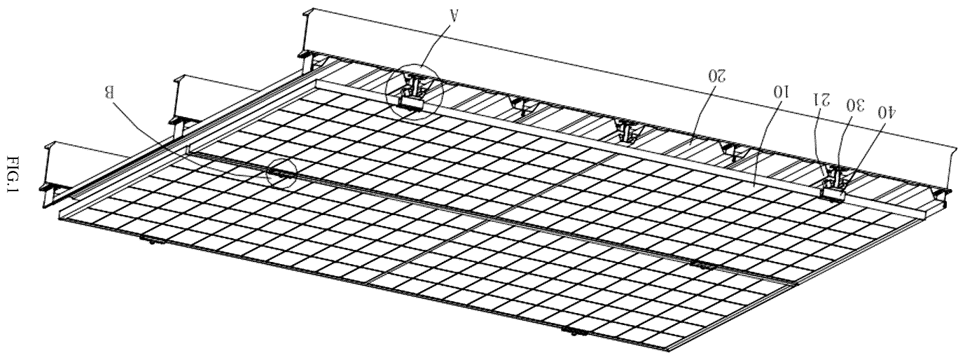

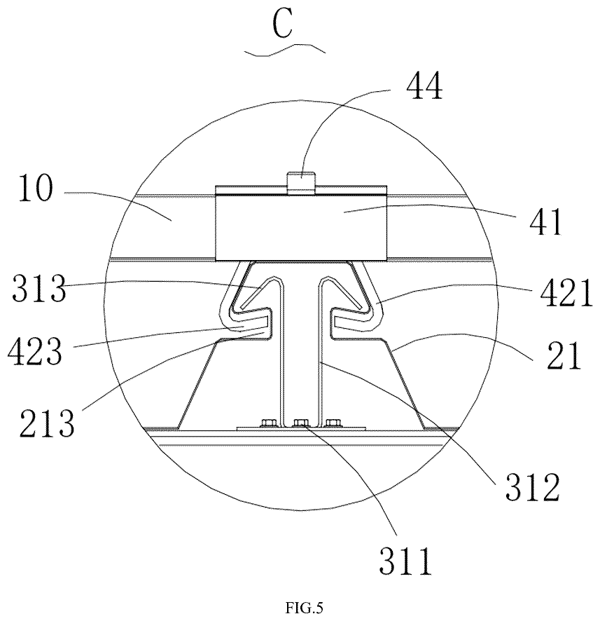

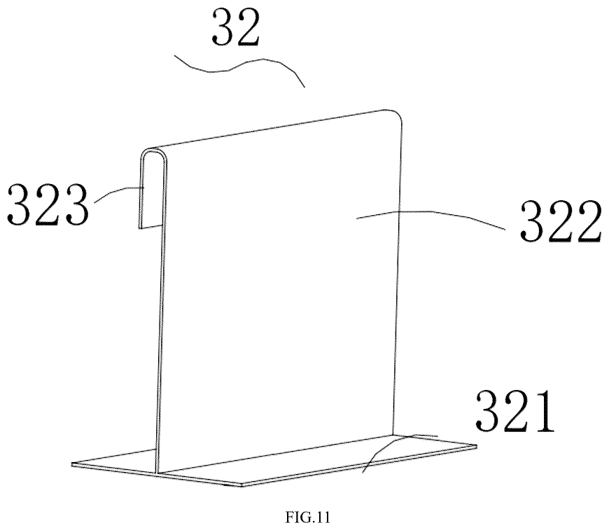

As shown in FIGS. 1 to 14, the present application provides a photovoltaic system, which includes photovoltaic modules 10, supporting metal sheets 20 for supporting and fixing the photovoltaic modules 10, an mounting device 30 for installing the supporting metal sheets 20 at the mounting site, and a mounting mechanism 40 for installing the photovoltaic modules 10 on the supporting metal sheets 20. The mounting site includes but is not limited to building roofs. For the purpose of illustration, the structure and mounting method of the photovoltaic system will be described with reference to a building roof.

The photovoltaic module 10 includes several solar panels and a frame 11 surrounding the solar panels. As shown in FIG. 1, the photovoltaic module 10 is rectangular, and the frame 11 includes a pair of long side frames extending along the length direction of the photovoltaic module 10 and a pair of short side frames extending along the width direction of the photovoltaic module 10. In other embodiments, the photovoltaic module 10 may have other shapes, and the shape of the frame 11 will adapt accordingly.

The supporting metal sheet 20 includes a support sheet 23 and a ridge structure 21 extending upward from the surface of the support sheet 23. The support sheet 23 is used to be laid on the surface of a building roof, and the ridge structure 21 extends along the length direction of the supporting metal sheet 20. The photovoltaic module 10 is installed on the ridge structure 21 via the mounting mechanism 40.

The supporting metal sheet 20 is also called “self-supporting metal sheet for roofing” or “color steel tile”.

In a preferred embodiment, the support sheet 23 is lower than the ridge structure 21. When the photovoltaic module 10 is installed on the ridge structure 21, there is a certain distance between the support sheet 23 and the photovoltaic module 10, forming a ventilation slot between the photovoltaic module 10 and the supporting metal sheet 20. This ventilation slot facilitates airflow at the bottom of the photovoltaic module 10, which is beneficial for heat dissipation.

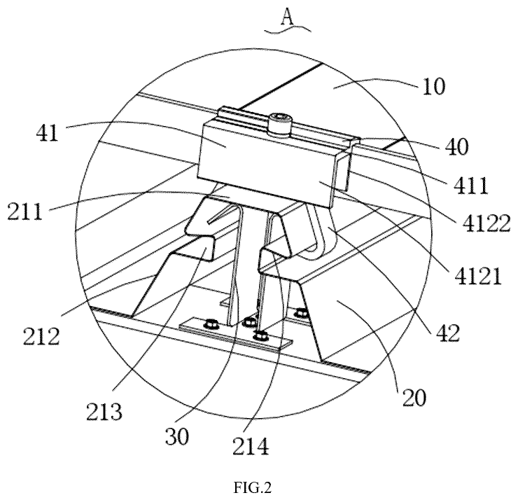

Further, as shown in FIGS. 2, 5, and 7, the ridge structure 21 includes a top plate 211 for supporting the photovoltaic module 10. The top plate 211 is located at the top of the ridge structure 21, and its width ranges from 10 mm to 200 mm. The top plate 211 has sufficient width to provide good support for the photovoltaic module 10, enabling it to withstand a large load pressure.

In some specific embodiments, the top plate 211 may be flat or may have a corrugated or other anti-slip surface structure to prevent the photovoltaic module 10 from sliding relative to the top plate 211, ensuring a more precise and efficient mounting process.

Further, the ridge structure 21 also includes a pair of side plates 212 connecting the top plate 211 to the support sheet 23. The pair of side plates 212 extend downward and away from each other from the top plate 211, meaning that the distance between the side plates 212 increases from top to bottom. The side plate 212 has a locking groove 213 formed by inward (toward the space between the pair of side plates 212). The locking groove 213 is located in the upper middle part of the ridge structure 21 and is used for mounting and fixing the supporting metal sheet 20, cooperating with the mounting device 30 to fix the photovoltaic module 10 on the supporting metal sheet 20.

The side plate 212 includes an inward-extending top wall 214, a vertical wall 215 extending downward from the top wall 214, and a bottom wall 216 extending outward from the vertical wall 215. The locking groove 213 is formed between the top wall 214, the vertical wall 215, and the bottom wall 216.

Preferably, the angle between the top wall 214 and the side plate 212 is an acute angle, and the top wall 214 extends inward and upward from the outside. This design prevents the installation device 30 and the mounting mechanism 40 from disengaging, providing a stronger wind-resistant effect.

The bottom wall 216 is parallel to the top plate 211, and the width ratio of the bottom wall 216 to the top plate 211 is in the range of 5% to 50%. This ensures that the locking groove 213 has sufficient depth, facilitating the fixation of the photovoltaic module 10 on the ridge structure 21, while also aiding in securing the supporting metal sheet 20 to the building roof through the ridge structure 21.

Further, as shown in FIGS. 1, 4, 7 to 9, the supporting metal sheet 20 also includes a first connecting structure 221 and a second connecting structure 222 respectively located on both sides of the ridge structure 21. Specifically, the first connecting structure 221 and the second connecting structure 222 are positioned at the edges of the supporting metal sheet 20 along the width direction. The first connecting structure 221 is used to mounting the second connecting structure 222 of an adjacent supporting metal sheet 20, connecting multiple supporting metal sheets 20 to meet the needs of larger areas.

The top width of the first connecting structure 221 or the second connecting structure 222 is relatively small. If the bottom end of the photovoltaic module 10 directly contacts the first connecting structure 221 or the second connecting structure 222, not only would the bottom end of the photovoltaic module 10 be prone to wear, posing a safety risk of failure, but it could also cause the fixed cooperation between the first connecting structure 221 and the second connecting structure 222 to fail, leading to water leakage at the joint between two supporting metal sheets 20.

To avoid direct contact between the first connecting structure 221 and the second connecting structure 222 with the bottom end of the photovoltaic module 10, the ridge structure 21 is higher than the height of the first connecting structure 221 or the second connecting structure 222. That is, when the photovoltaic module 10 is positioned on the supporting metal sheet 20, there is a certain distance between the first connecting structure 221 or the second connecting structure 222 and the bottom end of the photovoltaic module 10.

Further, the first connecting structure 221 has a first mounting groove 2211 with an opening facing downward, and the second connecting structure 222 has a second mounting groove 2221 with an opening facing downward. The inner diameter of the first mounting groove 2211 is larger than that of the second mounting groove 2221. The second connecting structure 222 is located within the first mounting groove 2211 of the adjacent supporting metal sheet 20. On one hand, this is used to fix and connect the two adjacent supporting metal sheets 20. On the other hand, since both the first mounting groove 2211 and the second mounting groove 2221 have openings facing downward, the seam between the first connecting structure 221 and the second connecting structure 222 is located below the first connecting structure 221 or the second connecting structure 222, preventing rainwater from flowing into the underside of the supporting metal sheet 20 through the seam. Of course, the inner diameter of the first mounting groove 2211 may be smaller than that of the second mounting groove 2221, with the connection method being the opposite of the above.

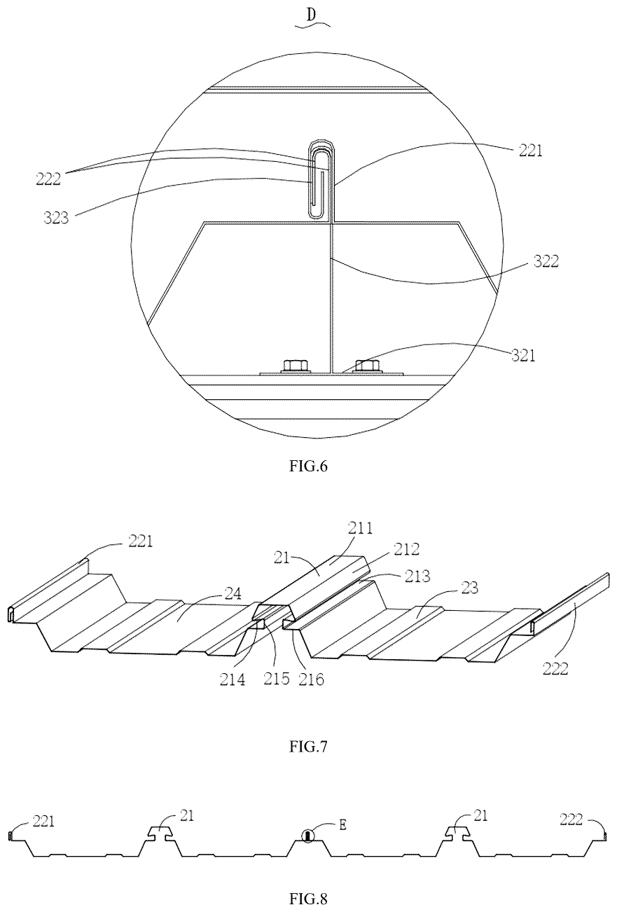

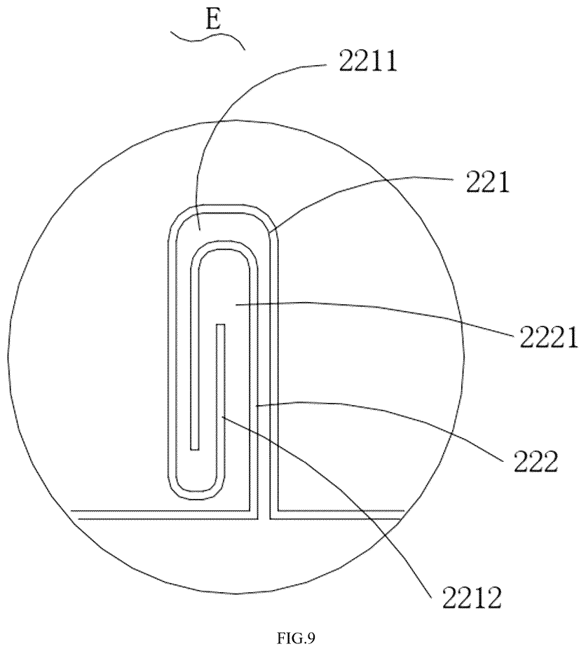

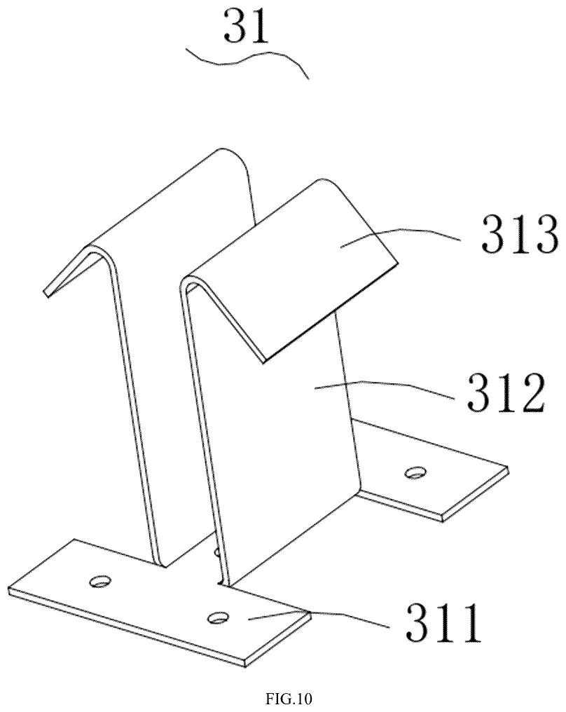

Referring to FIGS. 6 and 9, the first connecting structure 221 includes a vertical edge extending upward from the edge of the support sheet 23 and a folded edge extending downward from the upper end of the vertical edge. The first mounting groove 2211 is formed between the folded edge and the vertical edge. The first connecting structure 221 also has a limiting plate 2212 provided at its end, which extends upward from the end of the folded edge and into the first mounting groove 2211. When the first connecting structure 221 of one supporting metal sheet 20 cooperates with the second connecting structure 222 of another supporting metal sheet 20, the second connecting structure 222 is located within the first mounting groove 2211, and the limiting plate 2212 is located within the second mounting groove 2221. This further enhances the lateral (direction of arrangement of adjacent supporting metal sheets 20) positioning of the first connecting structure 221 and the second connecting structure 222, preventing lateral displacement of the first connecting structure 221 and the second connecting structure 222, thereby avoiding failure of the cooperation between the first connecting structure 221 and the second connecting structure 222.

The shapes of the first connecting structure 221 and the second connecting structure 222 can be formed before they are joined together, and more preferably, they can be bent or rolled together after being joined.

Further, the supporting metal sheet 20 also includes drainage channel 24 spaced apart on the support sheet 23. The drainage channel 24 are used to channel rainwater on the supporting metal sheet 20, preventing the accumulation of water and the risk of water leakage from the supporting metal sheet 20. The drainage channel 24 extend along the length direction of the supporting metal sheet 20 and are parallel to the ridge structure 21. Preferably, the drainage channel 24 are formed by partially indenting the support sheet 23 downward, with the side walls of the drainage channel 24 being inclined, which enhances the drainage effect of the drainage channel 24.

The mounting device 30 is used to mounting the supporting metal sheet 20 onto the building roof. The installation device 30 includes a central bracket 31 fixed at the ridge structure 21 for securing the supporting metal sheet 20, and a edge bracket 32 for fixing the joint between two adjacent supporting metal sheets 20.

In one embodiment, as shown in FIGS. 2 and 10, the central bracket 31 includes a support base 311, a pair of support plates 312 extending upward from the support base 311, and a locking plate 313 connected to the upper ends of the support plates 312 and extending outward. The support plates 312 and the locking plate 313 are configured to be inserted into the ridge structure 21, with the locking plate 313 located above the top wall 214, allowing them to interlock and prevent the ridge structure 21 from disengaging.

When fixing the supporting metal sheet 20, the support base 311 is first fixed to the building roof, and then the ridge structure 21 of the supporting metal sheet 20 is aligned with the central bracket 31 and pressed downward so that the central bracket 31 is inserted into the ridge structure 21. After mounting, the support plates 312 are located between the vertical walls 215 of the two side plates 212, and the locking plate 313 is located above the top wall 214. The locking plate 313 and the top wall 214 interlock to secure the supporting metal sheet 20 to the building roof.

Further, the angle between the locking plate 313 and the support plate 312 is also an acute angle, and the angle between the locking plate 313 and the support plate 312 is smaller than the angle between the top wall 214 and the support plate 312. The locking plate 313 has a larger inclination angle, resulting in a greater vertical component of the force applied by the locking plate 313 to the top wall 214, enhancing the fixing strength of the supporting metal sheet 20 and thereby improving the load-bearing capacity of the supporting metal sheet 20 and the photovoltaic module 10 installed thereon.

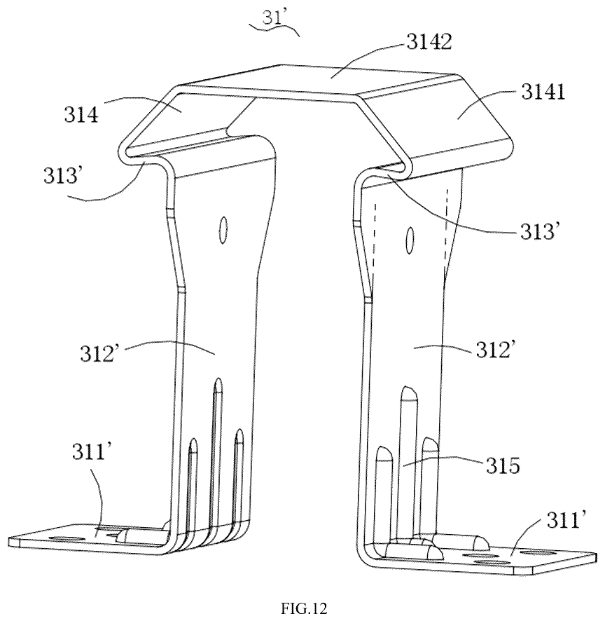

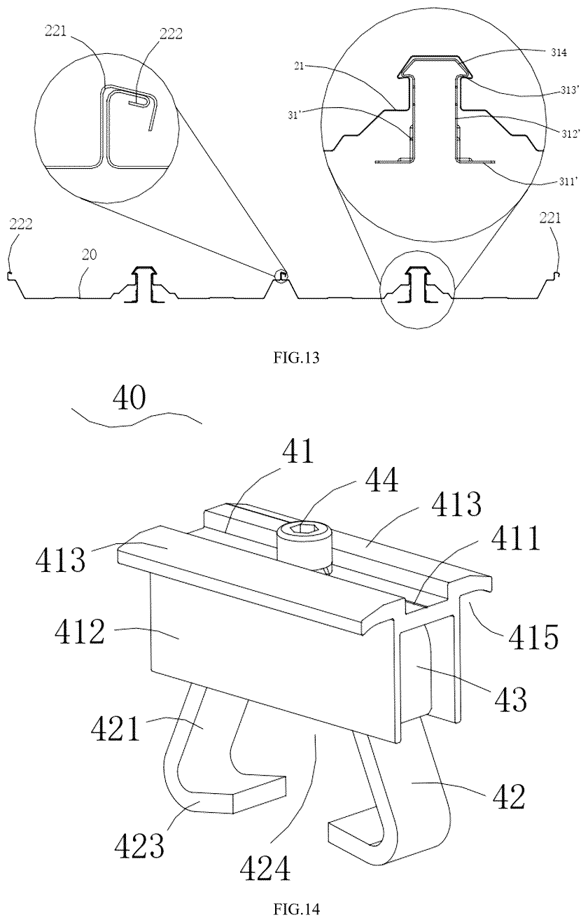

In another embodiment, as shown in FIGS. 12 and 13, another central bracket 31′ is provided. The central bracket 31′ differs from the central bracket 31 shown in FIG. 10 mainly in that it further includes a support plate 314, the support plate 314 is connected to the pair of locking plates 313′ for supporting the ridge structure 21 above the top wall 214, enhancing the load-bearing capacity and also providing a dual-side prevention against disengagement.

Specifically, the central bracket 31′ includes a support base 311′, a pair of support plates 312′ extending upward from the support base 311′, a pair of locking plates 313′ extending upward and outward from the upper ends of the support plates 312′, and a support plate 314 connected to the pair of locking plates 313′. The support plate 314 includes a pair of first support plates 3141 for supporting the side plates 212 above the top wall 214 and a second support plate 3142 for supporting the top plate 211. Specifically, the pair of locking plates 313′ extend upward and outward from the upper ends of the support plates 312′, and the pair of first support plates 3141 extend upward and toward each other from the tops of the clamping plates 313′ (the end remote from the support plates 312′), while the second support plate 3142 extends from the top of one first support plate 3141 to the top of the other first support plate 3141. In this embodiment, the central bracket 31′ is integrally formed.

Further, the width of the top of the support plate 312′ (corresponding to the extension direction of the ridge structure 21) is greater than the width of the bottom, providing a larger support surface for the ridge structure 21 and using more material, resulting in higher strength and preventing deformation.

Additionally, reinforcing ribs 315 are provided on the support plate 312′ and/or the support base 311′ to prevent deformation of the support plate 312′ under tension and to enhance the strength of the central bracket 31′.

Referring to FIGS. 1, 4, and 11, the edge bracket 32 is located between the first connecting structure 221 and the second connecting structure 222, and is positioned within the first fixing slot 2211 or the second fixing slot 2221.

Specifically, the edge bracket 32 includes a fixed base 321, an extension plate 322 extending upward from the fixed base 321, and a locking plate 323 extending downward from the upper end of the extension plate 322. The locking plate 323 and the extension plate 322 together form a receiving space.

The fixing method of the edge bracket 32 for the first connecting structure 221 and the second connecting structure 222 is as follows: first, the fixed base 321 is fixed to the building roof, and two adjacent supporting metal sheets 20 are laid on both sides. The first connecting structure 221 and the second connecting structure 222 are located on both sides of the edge bracket 32, and then the three components are bent and wrapped together to connect them.

After installation, the second connecting structure 222 is located within the first mounting groove 2211, the extension plate 322 extends upward from between the first connecting structure 221 and the second connecting structure 222, and the top of the extension plate 322 and the locking plate 323 are located within the first mounting groove 2211. The second connecting structure 222 is located within the receiving space, and the locking plate 323 and the extension plate 322 wrap around the second connecting structure 222 to fix it.

Alternatively, after fixing the supporting metal sheet 20, the first connecting structure 221 is located within the second mounting groove 2221, the extension plate 322 extends upward from between the first connecting structure 221 and the second connecting structure 222, and the top of the extension plate 322 and the locking plate 323 are located within the second mounting groove 2221. The first connecting structure 221 is located within the receiving space, and the locking plate 323 and the extension plate 322 wrap around the first connecting structure 221 to fix it.

As shown in FIGS. 1 and 4, the photovoltaic module 10 is installed on the ridge structure 21 of the supporting metal sheet 20 via the mounting mechanism 40.

Specifically, the frame 11 is pressed onto the ridge structure 21 by the mounting mechanism 40, i.e., the frame 11 is clamped between the mounting mechanism 40 and the ridge structure 21. Preferably, the long side frame of the photovoltaic module 10 is perpendicular to the length direction of the ridge structure 21. This arrangement ensures that the contact points between the frame 11 of the photovoltaic module 10 and the ridge structure 21 are evenly distributed, balancing the forces between the photovoltaic module 10 and the supporting metal sheet 21. This prevents structural failure of the supporting metal sheet 20 due to stepping, thereby avoiding installation failure, and improves the accuracy of the installation, thereby enhancing the overall structural stability of the photovoltaic system.

In a preferred embodiment of the present application, the length of the photovoltaic module 10 is n times the width of the supporting metal sheet 20, where n≥1. The width of n supporting metal sheets 20 after joined together is exactly the same as the length of the photovoltaic module 10, improving the adaptability of the supporting metal sheet 20 and saving material usage.

Of course, in other embodiments, the short side frame of the photovoltaic module 10 may also be perpendicular to the length direction of the ridge structure 21.

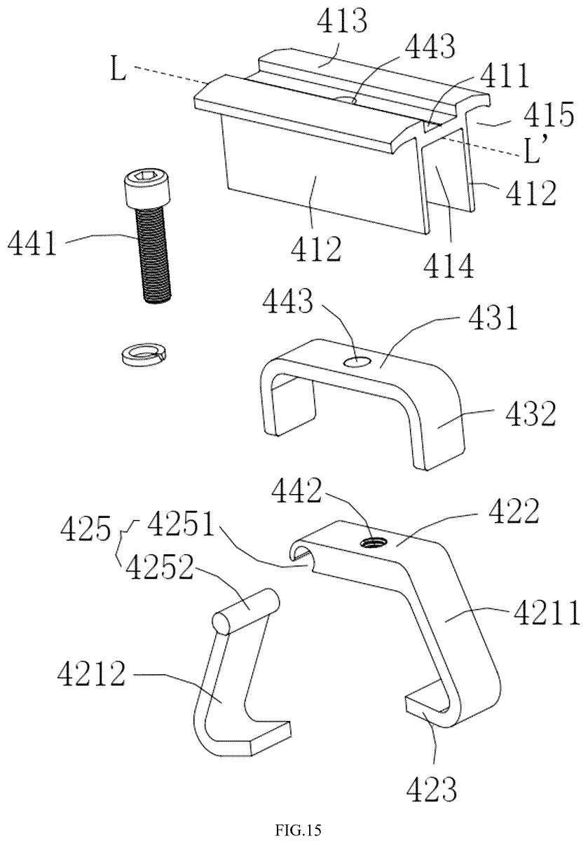

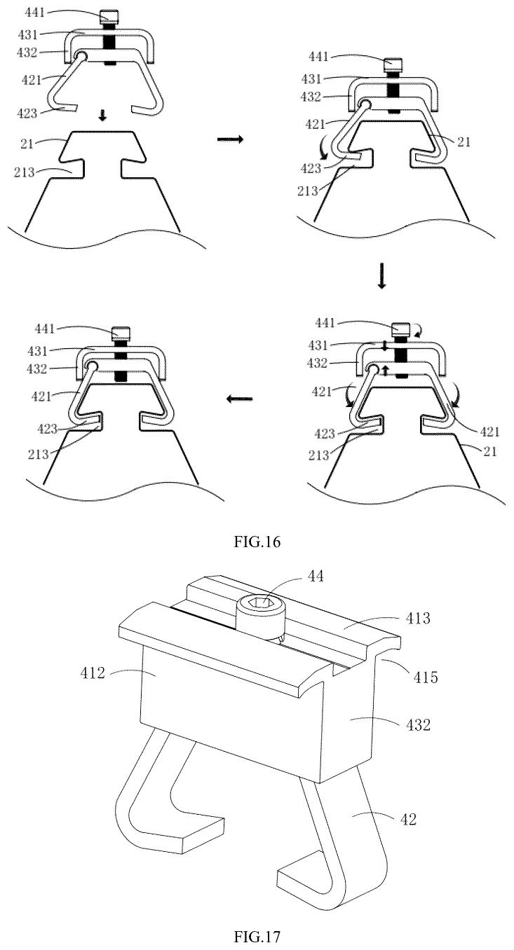

As shown in FIGS. 14 to 16, the mounting mechanism 40 includes a pressing block structure 41 and a clamping structure 42 located below the pressing block structure 41. The clamping structure 42 is used to clamp the supporting metal sheet 20, while the pressing block structure 41 is used to press the photovoltaic module onto the ridge structure 21. The cooperation between the pressing block structure 41 and the clamping structure 42 effectively simplifies the installation steps of the photovoltaic module 10 and improves work efficiency.

Specifically, the pressing block structure 41 includes a fixing plate 411, a pair of vertical plates 412 extending downward from the fixing plate 411, and a pressing plate 413 located at the side of the fixing plate 411 in the width direction, used to press the photovoltaic module 10 onto the ridge structure 21 for fixation.

The length of the fixing plate 411 is oriented along the length direction of the frame 11 of the photovoltaic module 10, and the frame 11 here is not limited to the long side frame or the short side frame of the photovoltaic module 10.

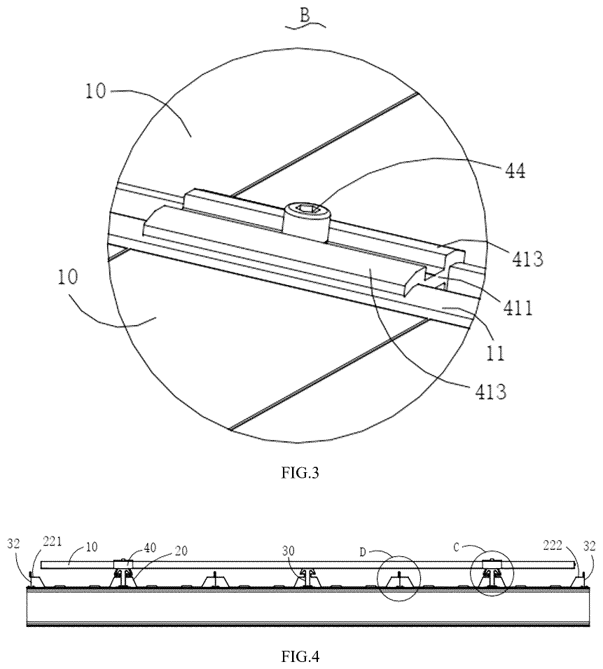

The pressing plate 413 is located at the side of the fixing plate 411 in the width direction, i.e., the pressing plate 413 and the fixing plate 411 are arranged along the width direction of the fixing plate 411. As shown in FIG. 2, when the mounting mechanism 40 is only used to fix one photovoltaic module 10, there is only one pressing plate 413, and it is located at any side of the fixing plate 411 in the width direction. As shown in FIG. 3, when the mounting mechanism 40 is located between two adjacent photovoltaic modules 10 and is used to fix both photovoltaic modules 10 simultaneously, there are two pressing plates 413, each located at opposite sides of the fixing plate 411 in the width direction.

A pair of vertical plates 412 are spaced apart along the width direction of the fixing plate 411 and are located at the bottom of the fixing plate 411. The ridge structure, the vertical plates 412, and the pressing plate 413 together form a fixing space 415 for fixing the photovoltaic module 10. Additionally, the pressing plate 413 and the vertical plates 412 also limit the upper part and the side walls of the frame 11, respectively, to prevent the photovoltaic module 10 from shifting. The length of the vertical plates 412 in the vertical direction is no greater than the thickness of the frame 11 of the photovoltaic module 10, so that the frame 11 of the photovoltaic module 10 can be supported on the ridge structure 21 of the supporting metal sheet 20. In other words, the frame 11 is clamped between the pressing plate 413 and the ridge structure 21, achieving vertical positioning of the photovoltaic module 10.

When there are two pressing plates 413, the pressing block structure 41 is symmetrically arranged along the centerline L-L′ in the width direction, ensuring balanced force distribution when fixing two photovoltaic modules 10 simultaneously. When only one pressing plate 413 is provided, the vertical plate 412 adjacent to the pressing plate 413 is referred to as the inner vertical plate 4122, and the vertical plate 412 remote from the pressing plate 413 is referred to as the outer vertical plate 4121. The thickness of the outer vertical plate 4121 is greater than that of the inner vertical plate 4122, enhancing the strength of the pressing block structure 41.

In this embodiment, an mounting groove 414 is formed between the pair of vertical plates 412, and a portion of the clamping structure 42 is located within the mounting groove 414. The pair of vertical plates 412 limits the clamping structure 42 in the width direction of the fixing plate 411, improving the structural strength of the mounting mechanism 40.

The clamping structure 42 includes a pair of clamping arms 421, which form a clamping space 424 for clamping the ridge structure 21. The inner diameter of the clamping space 424 in the horizontal direction varies with the force applied to the pair of clamping arms 421. The variation in the inner diameter of the clamping space 424 in the horizontal direction is used to tighten the ridge structure 21 of the supporting metal sheet 20, enhancing the secure installation of the photovoltaic module 10 and improving its load-bearing capacity.

Specifically, when the clamping arms 421 clamp the ridge structure 21 of the supporting metal sheet 20, the inner diameter of the clamping space 424 in the horizontal direction can be increased. After installation, the clamping space 424 can be tightened by applying force to the pair of clamping arms 421, reducing its inner diameter to clamp the ridge structure 21, simplifying the installation process and improving work efficiency. Moreover, the clamping arms 421 clamp the ridge structure 21, making the combination of the mounting mechanism 40 and the supporting metal sheet 20 more stable.

In this embodiment, one of the clamping arms 421 has a connecting plate 422 extending from its upper end, and the other clamping arm 421 is pivotally connected to the connecting plate 422. The connecting plate 422 is located between the pair of vertical plates 212, which limit the clamping structure 42 in the horizontal direction.

As shown in FIGS. 13 and 14, the clamping arm 421 that extends to form the connecting plate 422 is referred to as the main clamping arm 4211, and the clamping arm 421 that is pivotally connected to the connecting plate 422 is referred to as the auxiliary clamping arm 4212. During the installation process on the supporting metal sheet 20, the auxiliary clamping arm 4212 can be opened, increasing the inner diameter of the clamping space 424 in the horizontal direction to facilitate placing the two clamping arms 4212 over the ridge structure 21. Then, the clamping arms 421 are tightened by reducing the force applied, decreasing the inner diameter of the clamping space 424 to tightly clamp the ridge structure 21. This design of the clamping structure 42 simplifies the installation process of the photovoltaic module 10 and enhances its stability, thereby improving the load-bearing capacity of the photovoltaic module 10.

In this embodiment, the clamping structure 42 further includes a pivot structure 425 connecting the connecting plate 422 and the auxiliary clamping arm 4212. The pivot structure 425 includes a pivot hole 4251 provided at the end of either the connecting plate 422 or the auxiliary clamping arm 4212, and a pivot shaft 4252 provided on the other component to cooperate with the pivot hole 4251. When the pivot hole 4251 is located on the connecting plate 422, the pivot shaft 4252 is located on the auxiliary clamping arm 4212, or vice versa.

Further, the pivot structure 425 also includes stop parts 4253 provided at both ends of the pivot shaft 4252 along its length direction (as shown in FIGS. 14 and 19). The diameter of the stop parts 4253 is larger than that of the pivot shaft 4252, and the stop parts 4253 are used to prevent the pivot shaft 4252 from falling out of the pivot hole 4251.

In some embodiments, the clamping arms 421 may also be directly fixed to the underside of the fixing plate 411 or detachably connected (e.g., by insertion) to the underside of the fixing plate 411. As long as the inner diameter of the clamping space 424 in the horizontal direction changes when the clamping arms 421 are subjected to external force, the purpose of clamping the supporting metal sheet 20 can be achieved. The external force may be elastic force, and the change in the inner diameter of the clamping space 424 caused by the elastic force of the clamping arms 421 or external elastic force is also within the scope of the present invention.

In this embodiment, the clamping structure 42 further includes clamping plates 423 provided at the lower ends of the clamping arms 421. The angle between the clamping plates 423 and the clamping arms 421 is less than 90°, and the two clamping plates 423 extend toward each other from the ends of the two clamping arms 421. When the clamping structure 42 is clamped onto the ridge structure 21, the clamping plates 423 extend into the locking groove 213. The clamping structure 42 exerts an additional force on the ridge structure 21 in the direction of extension of the clamping plates 423. In this embodiment, the connecting plate 422 exerts a downward pressure on the ridge structure 21, while the clamping plates 423 exert a clamping force on the ridge structure 21 with an upward component. The clamping arms 421 exert a lateral clamping force on the ridge structure 21. Thus, the supporting metal sheet 20 is subjected to external forces from four directions by the clamping structure 42, enhancing the stability of the installation.

Additionally, when the mounting mechanism 40 is engaged with the ridge structure 21, the inclination angle of the clamping plates 423 is the same as that of the top wall 214, resulting in a larger contact area between the clamping plates 423 and the top wall 214 and improving the bonding strength between the mounting mechanism 40 and the ridge structure 21.

Further, as shown in FIGS. 14 to 16, the mounting mechanism 40 also includes a positioning structure 43 located between the pressing block structure 41 and the clamping structure 42. The positioning structure 43 includes positioning plates 432 provided below the fixing plate 411. The length direction of the positioning plates 432 is oriented in the vertical direction, and their ends can abut against the outer sides of the clamping arms 421, used to install the clamping structure 42 to the final position on the supporting metal sheet 20.

As another preferred embodiment of the present invention, as shown in FIGS. 14 to 16, the positioning structure 43 further includes a connecting plate 431 provided below the fixing plate 411. The positioning plates 432 are fixed to both ends of the connecting plate 431 in the length direction, and the ends of the positioning plates 432 remote from the connecting plate 431 can abut against the outer sides of the clamping arms 421. That is, the positioning plates 432 abut against the outer sides of the clamping arms 421 to exert an external force on them. After being subjected to the abutting force of the positioning plates 432, the two clamping arms 421 move toward each other, reducing the inner diameter of the clamping space 424 in the horizontal direction to clamp the ridge structure 21, thereby fixing the photovoltaic module 10 on the supporting metal sheet 20.

Preferably, the connecting plate 431 is located within the mounting groove 414, and the pair of vertical plates 412 limit the clamping structure 42 and the auxiliary positioning structure 43 in the horizontal direction, increasing the overall stability of the mounting mechanism 40).

In this embodiment, the connecting plate 431 is located between the fixing plate 411 and the connecting plate 422, and the length extension direction of the connecting plate 431 and the connecting plate 422 is the same, both extending along the length direction of the fixing plate 411.

It is understood that the positioning plates 432 may extend vertically downward or at an angle, as long as the positioning plates 432 can abut against the outer sides of the clamping arms 421 after moving downward, achieving the purpose of exerting an external force on the clamping arms 421.

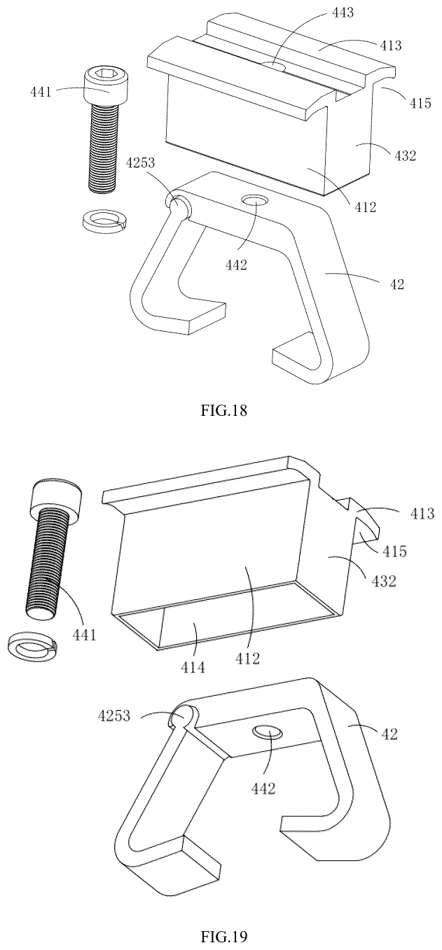

As another preferred embodiment of the present invention, as shown in FIGS. 17 to 19, the difference from the above embodiment (as shown in FIGS. 14 to 16) is only that the positioning plates 432 extend downward from the ends of the fixing plate 411. The positioning plates 432 are located between the pair of vertical plates 412 and are directly fixed to the fixing plate 411, simplifying the design of the pressing block structure 41, further reducing the material usage of the components, and lowering the weight of the mounting mechanism 401.

In this embodiment, the positioning plates 432 and the side portions of the vertical plates 412 are fixed together to form an mounting groove 414. The connecting plate 422 of the clamping structure 42 is located within the mounting groove 414, providing horizontal restraint to the clamping structure 42 and enhancing the overall structural strength of the mounting mechanism 40.

As another preferred embodiment of the present invention, the mounting mechanism 40) further includes a connection component 44 for connecting the pressing block structure 41, the positioning structure 43, and the clamping structure 42. The connection component 44 includes a fastener 441, a mounting hole 442 on the connecting plate 422 that cooperates with the fastener 441, and through holes 443 on the fixing plate 411 and the connecting plate 431. The fastener 441 is threaded into the mounting hole 442, while the through holes 443 are not threaded. The fastener 441 passes through the through holes 443 on the fixing plate 411 and the connecting plate 431, and then into the mounting hole 442 on the connecting plate 422. During the rotation of the fastener 441, the clamping structure 42 moves upward until the clamping arms 421 abut against the ends of the positioning plates 432. The ends of the positioning plates 432 then press against the outer sides of the clamping arms 421. Further rotation of the fastener 441 reduces the inner diameter of the clamping space 424 in the horizontal direction.

In the present invention, the steps for installing the photovoltaic module 10 include:
1. Laying the Supporting metal sheet: First, fix the central bracket 31 and the edge bracket 32 to the building roof. Then, clamp the ridge structure 21 of the supporting metal sheet 20 onto the central bracket 31, and position the edge bracket 32 between the adjacent first connecting structure 221 and second connecting structure 222. Finally, fix the joints between adjacent supporting metal sheets 20, for example, by bending or rolling the first connecting structure 221, the edge bracket 32, and the second connecting structure 222 together.
2. Placing the Photovoltaic Module 10: Place the photovoltaic module 10 on the supporting metal sheet 20 so that its frame 11 is perpendicular to the ridge structure 21. Preferably, the long side frame is perpendicular to the ridge structure 21.
3. Installing the Photovoltaic Module 10 via the Mounting Mechanism 40: Position the pressing block structure 41, the auxiliary positioning structure 43 (not necessarily required), and the clamping structure 42 from top to bottom. The fastener 441 passes through the through holes 443 on the fixing plate 411 and the connecting plate 431, and then into the mounting hole 442 on the connecting plate 422 to connect the three components into a single unit. The positioning plates 432 are located above the clamping arms 421. Rotate the auxiliary clamping arm 4212 to increase the inner diameter of the clamping space 424 so that it can be fitted over the ridge structure 21. The clamping plates 423 extend into the locking groove 213, and the auxiliary clamping arm 4212 is reset. Move the mounting mechanism 40 so that the pressing plate 413 is above the frame 11, then rotate the fastener 441. The clamping structure 42 moves upward, causing the positioning plates 432 to press against the clamping arms 421. The shape of the clamping arms 421 matches the shape of the ridge structure 21, ensuring a tight fit within the clamping space 424 and pressing the frame 11 of the photovoltaic module 10 onto the ridge structure 21.

Specifically, when only one pressing plate 413 is provided in the mounting mechanism 40, it is used to install the photovoltaic module 10 at the edge. After moving the mounting mechanism 40 so that the pressing plate 413 is above the frame 11, the fastener 441 can be rotated. When two pressing plates 413 are provided in the mounting mechanism 40, it is used to install two adjacent photovoltaic modules 10 simultaneously. After the first photovoltaic module 10 is installed, the mounting mechanism 40 is installed with one pressing plate 413 above the frame of the first photovoltaic module 10. Then, the second photovoltaic module is placed, and the terminal boxes of the two photovoltaic modules are connected. Next, adjust the second photovoltaic module 10 so that its frame is below the other pressing plate 413, and then rotate the fastener 441.

In summary: the photovoltaic system of the present invention presses the photovoltaic module 10 onto the ridge structure 21 via the mounting mechanism 40, ensuring that the photovoltaic module 10 is supported on the ridge structure 21, resulting in a stable installation structure. Additionally, by optimizing the arrangement of the photovoltaic module 10 and the supporting metal sheet 20, the long side of the photovoltaic module 10 is perpendicular to the direction of the ridge structure 21. This ensures that the contact points between the frame 11 of the photovoltaic module 10 and the ridge structure 21 are evenly distributed, balancing the forces between the photovoltaic module 10 and the supporting metal sheet 20. This prevents installation failure caused by uneven force distribution on the supporting metal sheet 20 and improves the accuracy of the installation, thereby enhancing the overall structural stability of the photovoltaic system.

It should be understood that although this specification describes various embodiments, it is not the case that each embodiment contains only a single independent technical solution. The manner in which the specification is written is merely for clarity. Those skilled in the art should consider the specification as a whole, and the technical solutions in the various embodiments can be appropriately combined to form other embodiments that can be understood by those skilled in the art. The detailed descriptions listed above are merely specific explanations of feasible embodiments of the present invention and are not intended to limit the scope of protection of the invention. Any equivalent embodiments or modifications made without departing from the spirit and scope of the invention should be included within the protection scope of the present invention.

What is claimed is:

1. A photovoltaic system, wherein, comprising:
a supporting metal sheet, the supporting metal sheet comprising a support sheet and a ridge structure extending upward from the surface of the support sheet;
a plurality of photovoltaic modules, each photovoltaic module comprising a frame;
a mounting mechanism fixed to the supporting metal sheet and configured to press the photovoltaic modules onto the ridge structure.

2. The photovoltaic system according to claim 1, wherein the mounting mechanism comprising:
a pressing block structure, the pressing block structure comprising a fixing plate, a pair of vertical plates extending downward from the fixing plate, and a pressing plate located at a side of the fixing plate in the width direction, the length of the vertical plates being no greater than the height of the frame, the frame being located between the pressing plate and the ridge structure;
a clamping structure located below the pressing block structure, the clamping structure comprising a pair of clamping arms located below the fixing plate, the pair of clamping arms forming a clamping space for accommodating the ridge structure, the inner diameter of the clamping space in the horizontal direction varying with the force applied to the pair of clamping arms.

3. The photovoltaic system according to claim 2, wherein:
the pressing block structure comprise one pressing plate located at any side of the fixing plate in the width direction; or
the pressing block structure comprise two pressing plates, each pressing plate being located at opposite sides of the fixing plate in the width direction.

4. The photovoltaic system according to claim 3, wherein when the pressing block structure comprise one pressing plate, the vertical plates comprise an outer vertical plate away from the pressing plate and an inner vertical plate close to the pressing plate, the thickness of the outer vertical plate being greater than the thickness of the inner vertical plate.

5. The photovoltaic system according to claim 2, wherein:
the clamping arms are fixed to the underside of the fixing plate or detachably connected to the underside of the fixing plate; or
one of the clamping arms comprise a connecting plate extending from its upper end, the other clamping arm being pivotally connected to the connecting plate, the connecting plate being located between the pair of vertical plates.

6. The photovoltaic system according to claim 5, wherein the fixing plate and the pair of vertical plates form an mounting groove, the connecting plate being located within the mounting groove, and the longitudinal direction of the connecting plate being aligned with the longitudinal direction of the fixing plate.

7. The photovoltaic system according to claim 5, wherein the mounting mechanism further comprises a connection component for connecting the pressing block structure and the clamping structure, the connection component comprising a fastener, a through hole in the fixing plate for the fastener to pass through, and a mounting hole in the connecting plate that cooperates with the fastener.

8. The photovoltaic system according to claim 7, wherein the mounting mechanism further comprises a positioning structure located between the pressing block structure and the clamping structure, the positioning structure comprising a pair of positioning plates located below the fixing plate, the positioning plates extending in the vertical direction, and the ends of the positioning plates being configured to abut against the outer side of the clamping arms when the positioning plates move in the vertical direction.

9. The photovoltaic system according to claim 8, wherein:
the positioning structure further comprise a connecting plate located below the fixing plate, the pair of positioning plates being respectively fixed to the ends of the connecting plate in the longitudinal direction, and a through hole being provided in the connecting plate at a position corresponding to the mounting hole for the fastener to pass through; or
the pair of positioning plates are respectively fixed to the ends of the fixing plate in the longitudinal direction, and the positioning plates extend downward from the ends of the fixing plate.

10. The photovoltaic system according to claim 2, wherein:
the ridge structure comprises a top plate for supporting the frame and a pair of side plates extending downward and away from each other from the ends of the top plate in the width direction, the side plates having a locking groove formed inwardly between the pair of side plates;
the clamping structure further comprise a clamping plate located at the lower end of each clamping arm, the clamping plates extending toward each other from the ends of the clamping arms, and the angle between the clamping plate and the clamping arm being an acute angle.

11. The photovoltaic system according to claim 1, wherein:
the ridge structure comprises a top plate for supporting the frame, a pair of side plates extending downward and away from each other from the ends of the top plate, the side plates comprising a top wall extending inwardly between the pair of side plates, the angle between the top wall and the side plates being an acute angle;
the photovoltaic system further comprises a central bracket, the central bracket comprising a support base, a pair of support plates extending upward from the support base, and a locking plate connected to the upper ends of the support plates and extending away from the other support plate, the support plates and the locking plate being configured to be inserted into the ridge structure, and the locking plate being located above the top wall.

12. The photovoltaic system according to claim 11, wherein the angle between the locking plate and the support plate is smaller than the angle between the top wall and the support plate.

13. The photovoltaic system according to claim 11, wherein the central bracket further comprise a support plate connected to the pair of locking plates, the support plate comprising a pair of first support plates for supporting the side plates above the top wall and a second support plate for supporting the top plate.

14. The photovoltaic system according to claim 13, wherein the width of the top of the support plate is greater than the width of the bottom, and/or at least one of the support plate and the support base is provided with a reinforcing rib.

15. The photovoltaic system according to claim 1, wherein the supporting metal sheet further comprises a first connecting structure and a second connecting structure respectively provided at the ends in the width direction, the first connecting structure being installed with the second connecting structure of an adjacent supporting metal sheet, and the height of the ridge structure being greater than the height of the first connecting structure and the second connecting structure.
